(19) United States
(12) Patent Application Publication
(10) Pub. No.: US 2024/0319571 A1
(43) Pub. Date: Sep. 26, 2024

(54) LIGHT VALVE ANGLE DYNAMIC ADJUSTMENT DEVICE FOR PROJECTOR

(71) Applicant: Young Optics Inc., Hsinchu (TW)

(72) Inventors: Wan-Chang Fan, Hsinchu (TW); Wei-Szu Lin, Hsinchu (TW)

(73) Assignee: Young Optics Inc., Hsinchu (TW)

(21) Appl. No.: 18/190,074

(22) Filed: Mar. 25, 2023

(51) Int. Cl. G03B 21/14

(52) U.S. Cl. CPC G03B 21/142

(57) ABSTRACT

A light valve angle dynamic adjustment device for a projector includes a light valve, a first movable portion, a first motor and a first mechanism. The light valve is arranged on a support of the first movable portion. The first motor is capable of driving the first mechanism. The first movable portion is also provided with a first rotation axis and a first mating portion. The first motor is capable of driving the first mechanism to make the first movable portion swing around the first rotation axis through the first mating portion.

### BACKGROUND

### Technical Field

The present disclosure relates to a dynamic adjustment device, and in particular to a light valve angle dynamic adjustment device for a projector.

### Description of Related Art

In current application of projectors, the typical requirement is that the projection surface and the optical axis of the projector lens are set at a fixed angle, so that the focal plane of the lens and the projection surface may be as consistent as possible. However, such approach causes restriction to end users. If the requirement set for the projection surface and the optical axis of the lens cannot be satisfied, there will be a difference between the focal plane and the projection surface, which results in unbalanced picture resolution and trapezoidal distortion.

### SUMMARY

The present disclosure provides a light valve angle dynamic adjustment device for a projector, which may dynamically adjust the angle of the light valve to achieve angle correction of a focal plane of the lens.

In the disclosure, a light valve angle dynamic adjustment device for a projector includes a light valve, which is arranged on a support of the first movable portion; a first motor, which is capable of driving the first mechanism; a first movable portion is further provided with a first rotation axis and a first mating portion; and the first motor is capable of driving the first mechanism to make the first movable portion swing around the first rotation axis through the first mating portion.

In an embodiment of the present disclosure, the first mechanism is a cam or a gear.

In an embodiment of the present disclosure, the first rotation axis is a solid axis, a hole or a corresponding axis.

In an embodiment of the present disclosure, the first mating portion is a slot.

In an embodiment of the present disclosure, the light valve angle dynamic adjustment device for a projector further includes a second motor capable of driving a second mechanism.

In an embodiment of the present disclosure, the light valve angle dynamic adjustment device for a projector further includes a second movable portion, which is arranged on the periphery of the first movable portion, and the second movable portion is further provided with a second rotation axis and a second mating portion.

In an embodiment of the present disclosure, the second motor is capable of driving the second mechanism to make the second movable portion swing around the second rotation axis through the second mating portion.

In an embodiment of the present disclosure, the second mechanism is a cam or a gear.

In an embodiment of the present disclosure, the second rotation axis is a solid axis, a hole or a corresponding axis.

In an embodiment of the present disclosure, the second mating portion is a slot.

In an embodiment of the present disclosure, the light valve angle dynamic adjustment device for a projector further includes a fixing member, wherein the second movable portion is assembled on the fixing member, and the first movable portion is assembled on the second movable portion.

In an embodiment of the present disclosure, the light valve angle dynamic adjustment device for a projector further includes a plate member, disposed between the first motor and the second movable portion.

In an embodiment of the present disclosure, an eccentricity of the second mechanism is approximately equal to a movement of the second movable portion.

In an embodiment of the present disclosure, the light valve angle dynamic adjustment device for a projector further includes a rubber member, located between the first movable portion and the light valve.

In an embodiment of the present disclosure, the light valve angle dynamic adjustment device for a projector further includes a flexible circuit board and a connector, wherein the connector is electrically connected to the flexible circuit board and the light valve.

In an embodiment of the present disclosure, the light valve angle dynamic adjustment device for a projector further includes a pressing plate and an elastic piece, wherein the pressing plate is located between the flexible circuit board and the elastic piece.

In an embodiment of the present disclosure, the light valve angle dynamic adjustment device for a projector further includes a heat dissipation fin, passing through the elastic piece and locked on the pressing plate.

In an embodiment of the present disclosure, the elastic piece, the pressing plate, the flexible circuit board, the connector, the light valve and the rubber member are assembled on the first movable portion.

In an embodiment of the present disclosure, an eccentricity of the first mechanism is approximately equal to a movement of the first movable portion.

In the present disclosure, a light valve angle dynamic adjustment device for a projector includes a base; a frame, which is located adjacent to the base; a first pair of rotation shafts, which are connected to the base and the frame; a carrier, which is located adjacent to the frame; a second pair of rotation shafts, which are connected to the frame and the carrier; a light valve, which is arranged on the carrier; a first power machine, which is capable of driving the frame to swing around the first pair of rotations shafts; and a second power machine, which is capable of driving the carrier to swing around the second pair of rotation shafts.

Based on the above, in the light valve angle dynamic adjustment device for a projector of the present disclosure, the light valve is arranged on the first movable portion, and the first motor is capable of driving the first mechanism to make the first movable portion swing around the first rotation axis through the first mating portion. In this way, the angle of the light valve may be dynamically adjusted, so that the light valve angle dynamic adjustment device for a projector of the present disclosure is able to achieve angle correction of the focal plane of the lens.

In order to make the above-mentioned features and advantages of the present disclosure more comprehensible, the specific examples below are described in detail in conjunction with the accompanying drawings.

### BRIEF DESCRIPTION OF THE DRAWINGS

FIG. 1 is a perspective view of a light valve angle dynamic adjustment device for a projector according to an embodiment of the present disclosure.

FIG. 2 is a perspective exploded view of the light valve angle dynamic adjustment device for a projector in FIG. 1.

### DESCRIPTION OF THE EMBODIMENTS

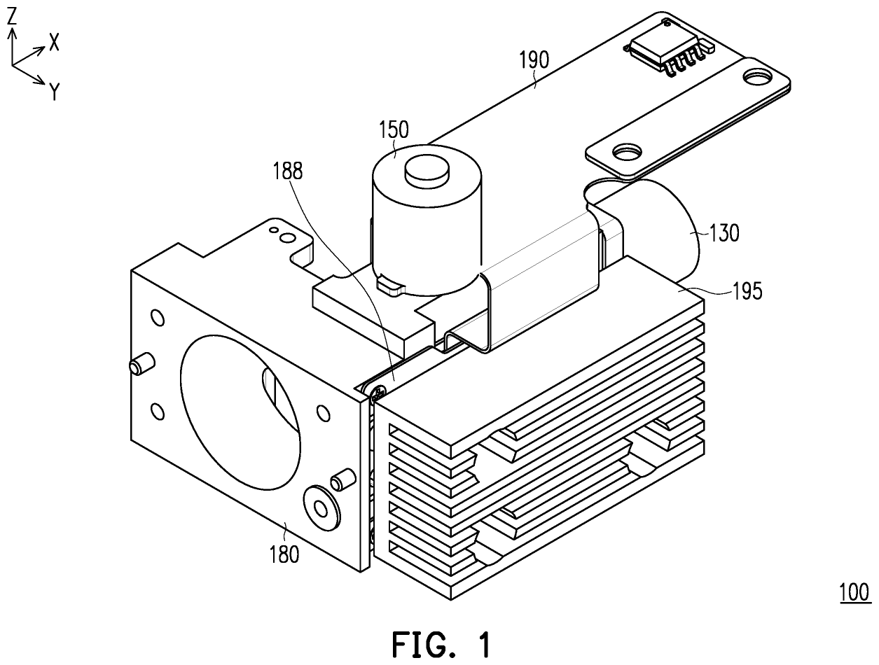

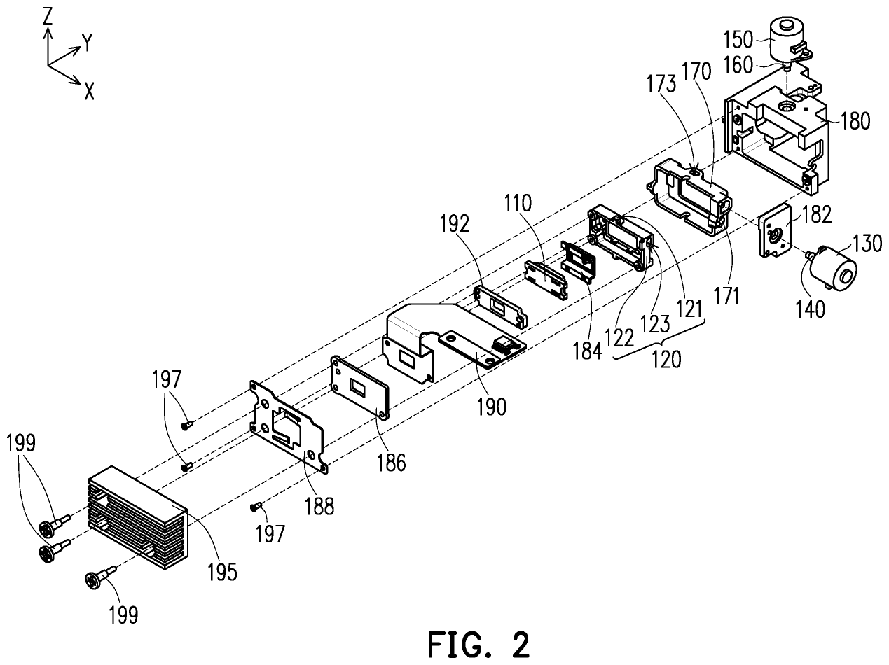

FIG. 1 is a perspective view of a light valve angle dynamic adjustment device for a projector according to an embodiment of the present disclosure. FIG. 2 is a perspective exploded view of the light valve angle dynamic adjustment device for a projector in FIG. 1. Please refer to FIG. 1 and FIG. 2 at the same time. In this embodiment, a light valve angle dynamic adjustment device for a projector 100 includes a light valve 110, a first movable portion 120, a first motor 130 and a first mechanism 140. The light valve 110 is disposed on a support 122 of the first movable portion 120, and the first movable portion 120 further has a first rotation axis 121 and a first mating portion 123. The first motor 130 is capable of driving the first mechanism 140 to make the first movable portion 120 swing around the first rotation axis 121 through the first mating portion 123. That is to say, the light valve 110 is disposed on the first movable portion 120, and the first motor 130 drives the first movable portion 120 to swing.

In an embodiment, the first rotation axis 121 of the first movable portion 120 is, for example, a solid axis, a hole or a corresponding axis, and the first mating portion 123 is, for example, a slot. The first mechanism 140 is, for example, a cam or a gear. Here, the first mechanism 140 is exemplified as an eccentric cam, but not limited thereto. The first mechanism 140 may be disposed corresponding to the first mating portion 123, and is driven by the first motor 130 to swing in the first mating portion 123 (such as simple harmonic motion, and the trajectory is in the shape of, for example, a bar). In an embodiment, the eccentricity of the first mechanism 140 (such as an eccentric cam) is approximately equal to the movement of the first movable portion 120 (such as the movement in the X direction).

Since the light valve 110 is arranged on the first movable portion 120, the first motor 130 is capable of driving the first mechanism 140 to make the first movable portion 120 swing around the first rotation axis 121 in the X-axis direction through the first mating portion 123. In this way, the angle of the light valve 110 may be dynamically adjusted to achieve wide-range angle correction of the focal plane of the lens.

Furthermore, please refer to FIG. 2 again, the light valve angle dynamic adjustment device for the projector 100 of this embodiment further includes a second motor 150, which is capable of driving a second mechanism 160. The light valve angle dynamic adjustment device for the projector 100 further includes a second movable portion 170, which is arranged on the periphery of the first movable portion 120, and the second movable portion 170 is further provided with a second rotation axis 171 and a second mating portion 173. The second motor 150 is capable of driving the second mechanism 160 to make the second movable portion 170 swing around the second rotation axis 171 through the second mating portion 173.

In an embodiment, the second rotation axis 171 of the second movable portion 170 is, for example, a solid axis, a hole or a corresponding axis, and the second mating portion 173 is, for example, a slot. The second mechanism 160 is, for example, a cam or a gear. Here, the second mechanism 160 is exemplified as an eccentric cam, but not limited thereto. The second mechanism 160 may be disposed corresponding to the second mating portion 173, and is driven by the second motor 150 to swing in the second mating portion 173 (such as simple harmonic motion, and the trajectory is in the shape of, for example, a bar). In an embodiment, the eccentricity of the second mechanism 160 (such as an eccentric cam) is approximately equal to the movement of the second movable portion 170 (such as the movement in the Z direction).

In addition, please refer to FIG. 1 and FIG. 2 at the same time. The light valve angle dynamic adjustment device for the projector 100 of the present embodiment further includes a fixing member 180, a plate member 182, a rubber member 184, a pressing plate 186, an elastic piece 188, a flexible circuit board 190 and a connector 192. The plate member 182 is disposed between the first motor 130 and the second movable portion 170. The rubber member 184 is located between the first movable portion 120 and the light valve 110. The connector 192 is electrically connected to the flexible circuit board 190 and the light valve 110. The pressing plate 186 is located between the flexible circuit board 190 and the elastic piece 188. The second movable portion 170 is assembled on the fixing member 180, and the first movable portion 120 is assembled on the second movable portion 170, and the elastic piece 188, the pressing plate 186, the flexible circuit board 190, the connector 192, the light valve 110 and the rubber member 184 are assembled on the first movable portion 120. A first locking member 197 passes through the elastic piece 188 to lock the above components on the fixing member 180. In addition, in order to increase the heat dissipation effect of the light valve angle dynamic adjustment device for the projector 100, the light valve angle dynamic adjustment device for the projector 100 in this embodiment may further include a heat dissipation fin 195, which passes through the elastic piece 188 through the second locking member 199 and is locked on the pressing plate 186. In an embodiment, the fixing member 180 is a base. The second movable portion 170 is a frame and is disposed adjacent to the base. The first movable portion 120 is a carrier and is located adjacent to the frame. The second rotation axis constitutes the first pair of rotation shafts and is connected to the base and the frame. The first rotation axis constitutes the second pair of rotation axes and is connected to the frame and the carrier. The light valve is arranged on the carrier, and the above-mentioned connection may be established through a pivot connection, or a mechanical direct or indirect connection as long as the connection ends are movable. For example, the second motor 150 is a first power machine, which may directly or indirectly (for example, through a linkage mechanism, such as a connection rod) drive the frame to swing around the first pair of rotation shafts. The first motor 130 is a second power machine, which may directly or indirectly (for example, through a linkage mechanism, such as a connection rod) drive the carrier to swing around the second pair of rotation shafts. The fixing member is a fixed part, and the movable portion is a moving or rotating part.

Since the light valve 110 is arranged on the first movable portion 120, the first motor 130 is capable of driving the first mechanism 140 to make the first movable portion 120 swing around the first rotation axis 121 in the X-axis direction through the first mating portion 123, and the second motor 150 is capable of driving the second mechanism 160 to make the second movable portion 170 swing around the second rotation axis 171 in the Z-axis direction through the second mating portion 173. In this way, the two-axis angles of the light valve 110 may be dynamically adjusted to achieve wide-range angle correction of the focal plane of the lens, so that the projection surface and the optical axis of the lens may still perform focusing within an angle of plus/minus 45 degrees. In this way, end users may make the projector to project obliquely or frontally or to lean forward or backward while maintaining a certain level of resolution.

To sum up, in the light valve angle dynamic adjustment device for the projector of the present disclosure, the light valve is arranged on the first movable portion, and the first motor is capable of driving the first mechanism to make the first movable portion swing around the first rotation axis through the first mating portion. In this way, the angle of the light valve may be dynamically adjusted, so that the light valve angle dynamic adjustment device for the projector of the present disclosure is able to achieve angle correction of the focal plane of the lens.

Although the present disclosure has been disclosed above with the embodiments, it is not intended to limit the present disclosure. Those with ordinary knowledge in the technical field may make some modifications and changes without departing from the spirit and scope of the present disclosure. Therefore, the scope to be protected by the present disclosure should be defined by the scope of appended claims.

What is claimed is:

1. A light valve angle dynamic adjustment device for a projector, comprising:
a light valve, which is disposed on a support of a first movable portion;
a first motor, which is capable of driving a first mechanism;
wherein the first movable portion is further provided with a first rotation axis and a first mating portion; and
the first motor is capable of driving the first mechanism to make the first movable portion swing around the first rotation axis through the first mating portion.

2. The light valve angle dynamic adjustment device for the projector according to claim 1, wherein the first mechanism is a cam or a gear.

3. The light valve angle dynamic adjustment device for the projector according to claim 1, wherein the first rotation axis is a solid axis, a hole or a corresponding axis.

4. The light valve angle dynamic adjustment device for the projector according claim 1, wherein the first mating portion is a slot.

5. The light valve angle dynamic adjustment device for the projector according to claim 1, further comprising:
a second motor, which is capable of driving a second mechanism.

6. The light valve angle dynamic adjustment device for the projector according to claim 5, further comprising:
a second movable portion, which is disposed on a periphery of the first movable portion, wherein the second movable portion is further provided with a second rotation axis and a second mating portion.

7. The light valve angle dynamic adjustment device for the projector according to claim 6, wherein the second motor is capable of driving the second mechanism to make the second movable portion swing around the second rotation axis through the second mating portion.

8. The light valve angle dynamic adjustment device for the projector according to claim 7, wherein the second mechanism is a cam or a gear.

9. The light valve angle dynamic adjustment device for the projector according to claim 7, wherein the second rotation axis is a solid axis, a hole or a corresponding axis.

10. The light valve angle dynamic adjustment device for the projector according to claim 7, wherein the second mating portion is a slot.

11. The light valve angle dynamic adjustment device for the projector according to claim 6, further comprising:
a fixing member, wherein the second movable portion is assembled on the fixing member, and the first movable portion is assembled on the second movable portion.

12. The light valve angle dynamic adjustment device for the projector according to claim 6, further comprising:
a plate member, disposed between the first motor and the second movable portion.

13. The light valve angle dynamic adjustment device for the projector according to claim 6, wherein an eccentricity of the second mechanism is approximately equal to a movement of the second movable portion.

14. The light valve angle dynamic adjustment device for the projector according to claim 1, further comprising:
a rubber member, located between the first movable portion and the light valve.

15. The light valve angle dynamic adjustment device for the projector according to claim 14, further comprising:
a flexible circuit board and a connector, wherein the connector is electrically connected to the flexible circuit board and the light valve.

16. The light valve angle dynamic adjustment device for the projector according to claim 15, further comprising:
a pressing plate and an elastic piece, wherein the pressing plate is located between the flexible circuit board and the elastic piece.

17. The light valve angle dynamic adjustment device for the projector according to claim 16, further comprising:
a heat dissipation fin, passing through the elastic piece and locked on the pressing plate.

18. The light valve angle dynamic adjustment device for the projector according to claim 16, wherein the elastic piece, the pressing plate, the flexible circuit board, the connector, the light valve and the rubber member are assembled on the first movable portion.

19. The light valve angle dynamic adjustment device for the projector according to claim 1, wherein an eccentricity of the first mechanism is approximately equal to a movement of the first movable portion.

20. A light valve angle dynamic adjustment device for a projector, comprising:
a base;
a frame, which is disposed adjacent to the base;
a first pair of rotation shafts, which are connected to the base and the frame;
a carrier, which is disposed adjacent to the frame;
a second pair of rotation shafts, which are connected to the frame and the carrier;
a light valve, which is disposed on the carrier;
a first power machine, which is capable of driving the frame to swing around the first pair of rotations shafts; and
a second power machine, which is capable of driving the carrier to swing around the second pair of rotation shafts.
